(19) United States
(12) Patent Application Publication
(10) Pub. No.: US 2026/0310442 A1
(43) Pub. Date: Oct. 8, 2026

(54) SYSTEMS AND METHODS FOR UPDATING ENERGY STORAGE MANAGEMENT SOFTWARE IN EMBEDDED SYSTEMS

(71) Applicant: ELECTRA VEHICLES, INC., Boston, MA (US)

(72) Inventors: Saurabh Sudhakar Bhasme, Allston, MA (US); Vaidyanathan Ramadurai, Bangalore (IN); Amol Khedkar, Olathe, KS (US); Dilip Warrier, Acton, MA (US); Fabrizio Martini, Boston, MA (US)

(73) Assignee: ELECTRA VEHICLES, INC., Boston, MA (US)

(21) Appl. No.: 19/510,244

(22) PCT Filed: Aug. 12, 2024
(86) PCT No.: PCT/US2024/041923

§ 371 Date: Feb. 10, 2026

Related U.S. Application Data
(60) Provisional application No. 63/518,914, filed on Aug. 11, 2023.

(51) Int. Cl. G06F 8/65; B60L 58/12; B60L 58/16; G06F 11/10; H04L 1/18; H04L 12/40

(52) U.S. Cl. CPC G06F 8/65; B60L 58/12; B60L 58/16; G06F 11/1004; H04L 1/18; H04L 12/40; H04L 2012/40215

(57) ABSTRACT

Methods and apparatus for updating an inference model being used by an embedded system of an energy application are provided. The method includes storing at a first memory location of a memory associated with an embedded system, a first instance of an inference model, storing at a second memory location of the memory, a second instance of the inference model, receiving updated information for the inference model, updating the second instance of the inference model based on the updated information, wherein updating the second instance is performed while the inference model is configured to estimate at least one aspect of the energy application using the first instance, and configuring the embedded system to use the second instance of the inference model to estimate the at least one aspect of the energy application when updating the second instance of the inference model is complete.

This disclosure relate to techniques for updating energy storage management software in an embedded system.

### BACKGROUND

The use of fossil fuels in transportation is a major source of air pollution. Traditional internal combustion engines emit many pollutants such as carbon oxides, nitrogen oxides, particulate matter, etc. Efforts have intensified in recent years to transition to electric vehicles, which have zero tailpipe emission, and thereby improve air quality and slow global warming.

Various types of energy storage technologies (e.g., electrochemical batteries, supercapacitors, hydrogen fuel cells, etc.) may be used to store energy harvested from renewable sources (e.g., solar, wind, and hydroelectric power) and power electric vehicles. These technologies are based on different principles of operation, and therefore have different characteristics. For instance, some energy storage devices (e.g., electrochemical batteries) may be able to store large amounts of energy on a unit mass basis and/or a unit volume basis, whereas some energy storage devices (e.g., supercapacitors) may be able to deliver large amounts of power on a unit mass basis and/or a unit volume basis.

Moreover, performance of an energy storage device may vary depending on one or more external conditions (e.g., temperature, humidity, barometric pressure, etc.) and/or one or more internal conditions (e.g., oxidation and/or buildup on electrodes). The one or more internal conditions may, in turn, depend on how the energy storage device has been used in the past. For instance, excessive heat produced by rapid discharge may cause damage to an electrochemical battery.

### SUMMARY

Some embodiments are directed to a computer-implemented method for updating one or more aspects of an inference model while the inference model is being used by an embedded system of an energy application. The computer-implemented method includes storing at a first memory location of a memory associated with an embedded system, a first instance of an inference model, storing at a second memory location of the memory, a second instance of the inference model, receiving, via a network, first updated information for the inference model, updating the second instance of the inference model based on the first updated information, wherein updating the second instance of the inference model is performed while the inference model is configured to estimate at least one aspect of the energy application using the first instance of the inference model, and configuring the embedded system to use the second instance of the inference model to estimate the at least one aspect of the energy application when updating the second instance of the inference model is complete.

In one aspect, the first instance of the inference model comprises a first set of parameters associated with the inference model and the second instance of the inference model comprises a second set of parameters associated with the inference model. In another aspect, the inference model comprises a machine learning model, the first set of parameters comprises a first set of weights and/or biases for the machine learning model, and the second set of parameters comprises a second set of weights and/or biases for the machine learning model. In another aspect, the first instance of the inference model and the second instance of the inference model are associated with different model architecture.

In another aspect, the computer-implemented method further includes determining that the second instance of the inference model is not being used by the embedded system, wherein updating the second instance of the inference model is performed in response to determining that the second instance of the inference model is not being used by the embedded system. In another aspect, determining the second instance of the inference model is not being used by the embedded system is based, at least in part, on a value stored in a location of the memory.

In another aspect, receiving first updated information for the inference model comprises receiving a plurality of packets, the computer-implemented method further includes reassembling the plurality of packets according to an order identified in the plurality of packets to generate updated model parameters, and updating the second instance of the inference model based on the first updated information comprises updating the second instance of the inference model based on the updated model parameters.

In another aspect, the computer-implemented method further includes requesting via the network, retransmission of a packet when the plurality of packets includes a missing packet according to the order identified in plurality of packets. In another aspect, receiving the plurality of packets comprises receiving the plurality of packets via an input/output (I/O) channel. In another aspect, the I/O channel comprises a controller area network (CAN) bus. In another aspect, the computer-implemented method further includes sending via the network, an acknowledgement that the plurality of packets were received.

In another aspect, reassembling the plurality of packets according to an order identified in the plurality of packets comprises reassembling the plurality of packets at the second memory location. In another aspect, the computer-implemented method further includes determining whether an updated second instance of the inference model using the updated model parameters is valid, and updating the second instance of the inference model is performed in response to determining that the updated second instance of the inference model is valid. In another aspect, determining whether an updated second instance of the inference model using the updated model parameters is valid comprises using a checksum technique. In another aspect, the computer-implemented method further includes discarding the updated second instance of the inference model when it is determined that the updated second instance of the inference model is not valid or when the plurality of packets includes a missing packet according to the order identified in plurality of packets.

In another aspect, the at least one aspect of the energy application includes one or more of state of charge or state of health of an energy storage management system of the energy application. In another aspect, the energy application comprises an electric vehicle.

In another aspect, configuring the embedded system to use the second instance of the inference model to estimate the at least one aspect of the energy application when updating the second instance of the inference model is complete comprises changing a value stored in a location of the memory, wherein the value corresponds to the first instance of the inference model or the second instance of the inference model. In another aspect, the location of the memory comprises a register and the value of stored in the location of the memory is a binary value. In another aspect, changing the value stored in a location of the memory comprises changing the value while the embedded system is configured to use the first instance of the inference model to estimate the at least one aspect of the energy application.

In another aspect, configuring the embedded system to use the second instance of the inference model to estimate the at least one aspect of the energy application when updating the second instance of the inference model is complete comprises updating a pointer in the memory. In another aspect, the computer-implemented method further includes receiving via the network, second updated information for the inference model, updating the first instance of the inference model based on the second updated information, wherein updating the first instance of the inference model is performed while the inference model is configured to estimate at least one aspect of the energy application using the second instance of the inference model. In another aspect, the computer-implemented method further includes configuring the embedded system to use the first instance of the inference model to estimate the at least one aspect of the energy application when updating the first instance of the inference model is complete.

In accordance with some embodiments, a computer-implemented method is provided for updating energy storage management software in embedded systems.

In accordance with some embodiments, a system is provided, comprising at least one processor and at least one computer-readable medium having stored thereon instructions which, when executed, program the at least one processor to perform any of the methods described herein.

In accordance with some embodiments, at least one computer-readable medium is provided, having stored thereon instructions which, when executed, program at least one processor to perform any of the methods described herein.

### BRIEF DESCRIPTION OF DRAWINGS

FIG. 1A shows an illustrative energy storage management system, in accordance with some embodiments.

FIG. 1B shows an illustrative remote energy storage management system and an illustrative local energy storage management system, in accordance with some embodiments.

FIG. 2A shows an illustrative machine learning model, in accordance with some embodiments.

FIG. 2B shows an illustrative set of machine learning models, in accordance with some embodiments.

FIG. 3 shows an illustrative process for updating energy storage management software, in accordance with some embodiments.

FIGS. 4A and 4B show an illustrative processor, in accordance with some embodiments.

FIG. 5 shows an illustrative system on which one or more aspects of the present disclosure may be implemented, in accordance with some embodiments.

### DETAILED DESCRIPTION

As discussed above, performance of an energy storage device may vary depending on one or more external conditions and/or one or more internal conditions. Moreover, there may be a tradeoff between short term and long term performance. For instance, to deliver high acceleration, an electrochemical battery may be discharged at a high rate, which may produce excessive heat, thereby damaging the battery and shortening its usable life.

Therefore, it may be desirable to manage energy storage systems in an adaptive manner. For example, charging and/or discharging of energy storage devices may be controlled dynamically, based on input variables such as external conditions, internal conditions, usage histories of the one or more energy storage devices, mission characteristics, operator preferences, etc.

An external or internal condition of an energy storage device may be determined in any suitable manner. For instance, in some embodiments, an external or internal condition may be measured using one or more sensors. Additionally, or alternatively, an external or internal condition may be derived from sensor data and/or other data (e.g., historical data relating to how the energy storage device has been used in the past). For example, the external or internal condition may be inferred by applying one or more machine learning models to the sensor data and/or the other data.

For some energy storage parameters, conventional inference techniques may be inadequate. For instance, it may be impossible or impractical to examine certain internal conditions of an electrochemical battery without physically disassembling the battery. Therefore, the battery's age (e.g., as measured by a number of charge/discharge cycles) may be used to provide a crude estimate for the battery's state of health (SoH). Such a crude estimate may not take into account usage history, and therefore may be inaccurate.

Additionally, or alternatively, a battery's SoH may be estimated based on a ratio (e.g., expressed as a percentage) between the battery's current maximum capacity (e.g., maximum charge capacity or maximum energy capacity) and the battery's rated capacity (e.g., rated charge capacity or rated energy capacity, respectively). Additionally, or alternatively, a battery's SoH may be estimated based on a ratio (e.g., expressed as a percentage) between the battery's current internal resistance (IR) and internal resistance (IRO) of a new battery of the same kind.

The inventors have recognized and appreciated that accuracy of such estimations may decline over time. For instance, accuracy of capacity estimates may decline over time (e.g., due to accumulated errors), which may negatively impact accuracy of SoH estimates.

By contrast, a machine learning model may be used to infer a battery's SoH with much higher accuracy. Such a model may be trained using historical data for a particular battery, such as measurements taken when the battery was new, and/or measurements taken during one or more past charge/discharge cycles.

The inventors have recognized and appreciated that, while more sophisticated inference techniques (e.g., those based on machine learning models) may provide more accurate results, it may be challenging to implement such inference techniques in a practical environment. For instance, a computing system embedded into a battery management system (BMS) may have one or more resource constraints, such as limited memory, limited processing cycles, limited network bandwidth, etc. It may be challenging to continually retrain a machine learning model on such a system. With less frequent retraining, or no retraining at all, accuracy of the machine learning model may decline over time.

In some embodiments, techniques are provided for updating energy storage management software in a resource-constrained environment such as an embedded processor. For instance, one or more resource intensive tasks, such as retraining of a machine learning model, may be performed by a computing system with more resources (e.g., a cloud server). Data for use in such a task may be transmitted by the embedded processor to the cloud server, and updated software may be transmitted by the cloud server back to the embedded processor.

The inventors have recognized and appreciated various challenges associated with receiving and installing updated software on an embedded processor in an electric vehicle.

As an example, energy storage management software may be in use continuously when an electric vehicle is in operation. Thus, conventional updates for energy storage management software may be performed only when an electric vehicle is not in operation. For instance, an update for energy storage management software may be performed when a battery pack is removed from an electric vehicle and submitted to a designated facility for maintenance, where updated software may be received via a wired connection to the battery pack. Even if updated software may be received via a wireless connection (and thus at any location), the received software may not be installed until the electric vehicle is at rest and turned off.

The inventors have recognized and appreciated that, if updated software is received and installed only when an electric vehicle is not in operation, a machine learning model may become outdated, and accuracy may suffer. Accordingly, in some embodiments, techniques are provided for updating software while the software is in use.

As another example, an embedded processor in an electric vehicle may not have a direct network connection to a cloud server where, for example, a machine learning model is retrained. Therefore, updated software (e.g., one or more aspects of a retrained machine learning model) may be received first by a gateway device connected to the cloud server. The gateway device may then pass the received software to the embedded processor, for instance, via an input/output (I/O) channel such as a controller area network (CAN) bus. In some embodiments, techniques are provided for packetizing information associated with updated software for transmission via an I/O channel.

As another example, an embedded processor may not have sufficient memory to hold, simultaneously: (i) existing software that is in use, and (ii) updated software that is being received via a network connection. Moreover, some embedded applications may not have any operating system at all, or may have an operating system with limited functionalities (e.g., no or limited memory management functionalities such as paging). Therefore, it may be impossible or impractical to update an entire energy storage management software package while such a software package is in use.

In some embodiments, one or more machine learning models within an energy storage management software package may be updated, instead of updating the entire package. For instance, no executable code, or only a limited amount of executable code (e.g., executable code that is part of a machine learning model, and/or an interface thereto), may be updated. In this manner, consumption of resources such as memory, processor cycles, network bandwidth, etc. may be reduced.

Indeed, in some instances, if a new machine learning model has the same architecture as an existing machine learning model, one or more parameter values of the machine learning model may be updated rather than updating the entire model. For instance, a neural network model may be retrained on a cloud server, and one or more new weights and/or biases may be transmitted by the cloud server to an embedded processor on which the model is deployed.

It should be appreciated that the techniques introduced above and described in greater detail below may be implemented in any of numerous ways, as the techniques are not limited to any particular manner of implementation. Examples of implementation details are provided herein solely for illustrative purposes. For instance, one or more of the techniques described herein may be used to manage energy storage systems in any suitable type of energy applications, in addition to, or instead of, electric vehicles.

Furthermore, one or more of the techniques described herein may be used to update software (e.g., machine learning models) for any suitable type of embedded applications, in addition to, or instead of, energy applications.

Further still, the techniques described herein may be used individually or in any suitable combination, as aspects of the present disclosure are not limited to using any particular technique or combination of techniques.

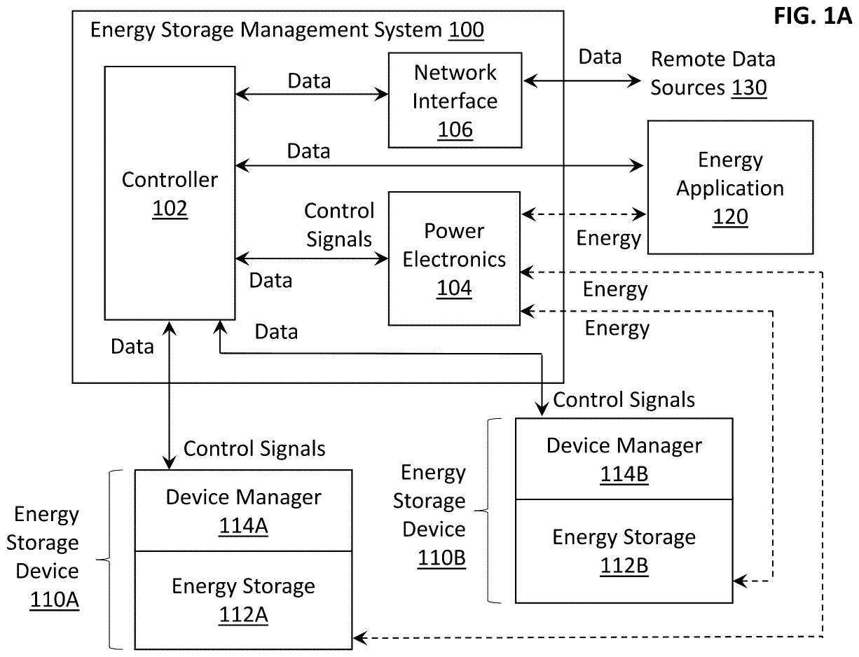

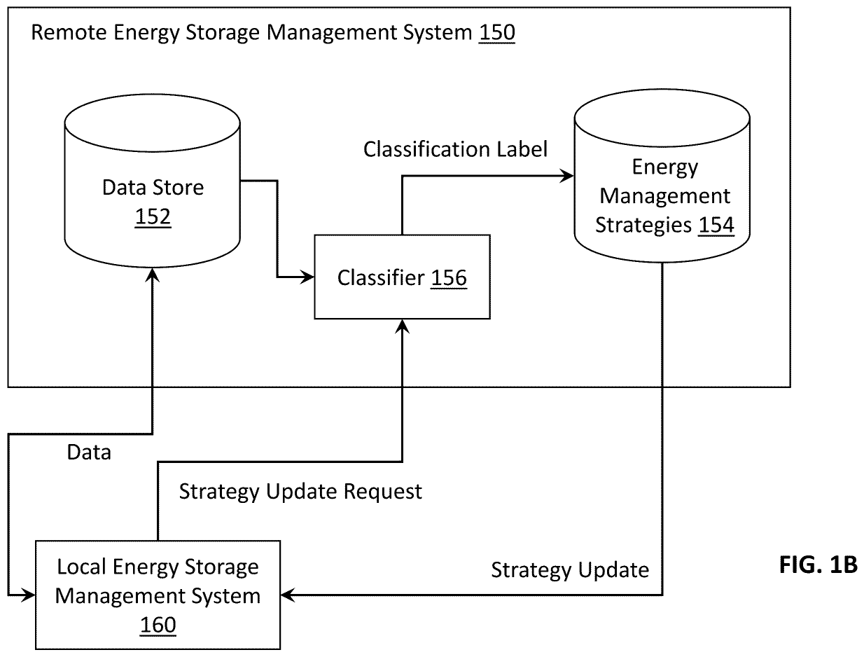

FIG. 1A shows an illustrative energy storage management system 100, in accordance with some embodiments. In this example, the illustrative energy storage management system 100 is used to manage energy storage devices 110A and 110B to supply energy to, and/or receive energy from, an energy application 120. The energy application 120 may be any suitable energy application, such as a vehicle, an appliance, a data center, an electric grid, etc. It should be appreciated that an energy application may fall within multiple ones of these categories. For instance, a warehouse robot may be both a vehicle and an appliance.

Examples of vehicles include, but are not limited to, land vehicles (e.g., cars, motorcycles, scooters, trams, etc.), watercrafts (e.g., boats, jet skis, hovercrafts, submarines, etc.), aircrafts (e.g., drones, helicopters, airplanes, etc.), and spacecrafts. It should be appreciated that a vehicle may fall within multiple ones of these categories. For instance, a seaplane may be both a watercraft and an aircraft.

Examples of appliances include, but are not limited to, robots, HVAC (heating, ventilation, and/or air conditioning) equipment, construction equipment, power tools, refrigeration equipment, and computing equipment. Such appliances may be used in any suitable setting, such as a residential setting, a commercial setting, and/or an industrial setting.

In some embodiments, the energy storage devices 110A and 110B may be of different types. For instance, the energy storage device 110A may have a higher energy density (and/or specific energy) compared to the energy storage device 110B. Additionally, or alternatively, the energy storage device 110B may have a higher power density (and/or specific power) compared to the energy storage device 110A. Accordingly, the energy storage device 110A and the energy storage device 110B are sometimes referred to herein as a “high energy” device and a “high power” device, respectively. Thus, it should be appreciated that the terms “high energy” and “high power” are used in a relative sense, as opposed to an absolute sense.

An energy storage system that includes two or more different types of energy storage devices is sometimes referred to herein as a “heterogeneous” energy storage system. For instance, a high energy device may be used to meet power demand that is relatively steady. When there is a spike in power demand, a high power device may be used in addition to, or instead of, the high energy device. However, it should be appreciated that aspects of the present disclosure are not limited to using a heterogeneous energy storage system. One or more of the techniques described herein may be used to manage an energy storage system having one or more energy storage devices of the same type. Such an energy storage system is sometimes referred to herein as a “homogeneous” energy storage system.

In the example of FIG. 1A, the energy storage device 110A includes an energy storage 112A, and the energy storage device 110B includes an energy storage 112B. In some embodiments, the energy storage 112A may include an electrochemical battery, whereas the storage 112B may include a supercapacitor. However, it should be appreciated that aspects of the present disclosure are not limited to using any particular energy storage technology or combination of energy storage technologies. In some embodiments, the energy storage 112A and 112B may both include electrochemical batteries, which may be of the same chemistry or different chemistries. In some embodiments, the energy storage 112A and 112B may both include supercapacitors, or other non-electrochemical energy storage units which may be of the same type or different types.

The energy storage 112A may be of any suitable construction. For instance, the energy storage 112A may use a liquid electrolyte, a solid electrolyte, and/or a polymer electrolyte. Moreover, the energy storage 112A may be a cell, a module, a pack, or another suitable unit that is individually controllable. Likewise, the energy storage 112B may be of any suitable construction, which may be the same as, or different from, the construction of the energy storage 112A.

In some embodiments, one or both of the energy storage device 110A and the energy storage device 110B may include a device manager. For instance, in the example of FIG. 1A, the energy storage device 110A and the energy storage device 110B include, respectively, device managers 114A and 114B.

As an example, the energy storage device 110A may be a smart battery pack, and the device manager 114A may be a BMS that is built into the smart battery pack. However, it should be appreciated that aspects of the present disclosure are not limited to having an integrated BMS. For instance, in some embodiments, the device manager 114B may be a BMS that is external to the energy storage 112B.

In some embodiments, a device manager (e.g., the device manager 114A or the device manager 114B) may be configured to monitor one or more aspects of an associated energy storage (e.g., the energy storage 112A or the energy storage 112B). Examples of monitored aspects include, but are not limited to, current, voltage, temperature, state of charge (e.g., percentage charged), state of health (e.g., present capacity as percentage of original capacity when the energy storage device was new), etc. For instance, the device manager may include one or more sensors configured to collect data from the associated energy storage. Additionally, or alternatively, the device manager may include one or more controllers configured to process data collected from the associated energy storage.

In some embodiments, a device manager may be configured to control an associated energy storage. For instance, the device manager may be configured to stop discharging of the associated energy storage in response to determining that a temperature of the associated energy storage has reached a selected threshold. Additionally, or alternatively, in an embodiment in which the associated energy storage includes a plurality of cells in series, the device manager may be configured to perform balancing, for example, by transferring energy from a most charged cell to a least charged cell.

In some embodiments, a device manager may be configured to transmit and/or receive data via a communication interface, such as a bus interface (e.g., CAN), a wireless interface (e.g., Bluetooth), etc. For instance, the device manager may be configured to transmit data to a controller 102 of the energy storage management system 100 via a CAN interface. Any suitable data may be transmitted, including, but not limited to, sensor data and/or one or more results of analyzing sensor data.

It should be appreciated that aspects of the present disclosure are not limited to using an energy storage device with an associated device manager. In some embodiments, one or more sensors external to an energy storage device may be used to monitor one or more aspects of the energy storage device, such as current, voltage, temperature, state of charge, state of health, etc.

In some embodiments, the controller 102 may receive data from the energy application 120 in addition to, or instead of, the device manager 114A and/or the device manager 114B. For instance, the energy application 120 may provide data indicating how much power the energy application 120 is currently drawing or supplying. Additionally, or alternatively, the energy application 120 may provide environmental data such as weather (e.g., temperature, humidity, atmospheric pressure, etc.), traffic (in case of a vehicle), etc. Additionally, or alternatively, the energy application 120 may provide operational data such as speed (in case of a vehicle), CPU usage (in case of computing equipment), load weight (in case of a warehouse robot or a drone), etc.

Additionally, or alternatively, the controller 102 may receive data from power electronics 104, which may include circuitry configured to distribute a demand or supply of power by the energy application 120 between the energy storage devices 110A and 110B. For instance, the power electronics 104 may provide data indicating whether the energy application 120 is currently drawing or supplying power, how much power the energy application 120 is currently drawing or supplying, and/or how that power is distributed between the energy storage devices 110A and 110B.

Additionally, or alternatively, the controller 102 may receive data from one or more remote data sources 130. For example, the energy storage management system 100 may include a network interface 106 configured to establish a connection using a suitable networking technology (e.g., 5G, WiMax, LTE, GSM, WiFi, Ethernet, Bluetooth, etc.). Although only one network interface is shown in FIG. 1A, it should be appreciated that aspects of the present disclosure are not so limited. In some embodiments, a plurality of network interfaces may be provided, which may be of the same type or different types. In some embodiments, no network interface may be provided, and the controller 102 may receive data from a remote data source via the energy application 120.

Moreover, it should be appreciated that data may be received from any suitable remote data source. For instance, the energy application 120 may be a vehicle in a fleet of vehicles, and the controller 102 may receive data from other vehicles in the fleet. Additionally, or alternatively, the controller 102 may receive data from a cloud server that is monitoring and/or controlling the fleet.

In some embodiments, the controller 102 may be configured to provide one or more control signals to the power electronics 104. For instance, the controller 102 may be configured to analyze data received from the energy storage device 110A, the energy storage device 110B, the power electronics 104, the energy application 120, and/or the one or more remote data sources 130. Based on a result of the analysis, the controller 102 may determine how a demand (or supply) of power by the energy application 120 should be distributed between the energy storage devices 110A and 110B, and/or whether energy should be transferred from the energy storage device 110A to the energy storage device 110B, or vice versa. The controller 102 may then provide one or more control signals to the power electronics 104 to effectuate the desired distribution of power and/or energy.

Although details of implementation are described above and shown in FIG. 1A, it should be appreciated that aspects of the present disclosure are not limited to any particular manner of implementation. For instance, while two energy storage devices (i.e., 110A and 1101B) are shown in FIG. 1A, it should be appreciated that aspects of the present disclosure are not limited to using any particular number of one or more energy storage devices. In some embodiments, just one energy storage device may be used, or three, four, five, etc. energy storage devices may be used.

Moreover, aspects of the present disclosure are not limited to having an energy storage management system in addition to a device manager. In some embodiments, there may be no controller 102, and the device manger 114A and/or the device manager 114B may interact directly with the network interface 106 to transmit data to, and/or receive data from, a cloud server. Additionally, or alternatively, one or more of the functionalities of the controller 102 may be performed by the device manger 114A and/or the device manager 114B.

Additionally, or alternatively, the network interface 106 may be integrated into an energy storage device (e.g., the energy storage device 110A or 110B), and therefore may be part of the same device as a device manger (e.g., the device manager 114A or 114B). Additionally, or alternatively, the network interface 106 may be integrated into an external device manager.

FIG. 1B shows an illustrative remote energy storage management system 150 and an illustrative local energy storage management system 160, in accordance with some embodiments. For instance, the local energy storage management system 160 may include the illustrative energy storage management system 100 in the example of FIG. 1A, and may be co-located with the illustrative energy application 120. By contrast, the remote energy storage management system 150 may be located away from the energy application 120, and may communicate with the local energy storage management system 160 via one or more networks. For instance, the remote energy storage management system 150 may be located at a cloud server, and may communicate with one or more local energy storage management systems that are associated, respectively, with one or more energy applications (e.g., a fleet of electric vehicles).

The inventors have recognized and appreciated that a local energy storage management system may have one or more resource constraints, such as limited memory and/or processing cycles. Accordingly, in some embodiments, the local energy storage management system 160 may transmit data to the remote energy storage management system 150 for storage and/or processing.

For instance, the remote energy storage management system 150 may include a data store 152, which may store data received from the local energy storage management system 160 and/or one or more other local energy storage management systems. Thus, the local energy storage management system 160 may store a smaller amount of historical data, such as data collected from the energy application 120 over a shorter period of time (e.g., past hour, day, week, etc.), whereas the remote energy storage management system 150 may store a larger amount of historical data, such as data collected from the energy application 120 over a longer period of time (e.g., past month, quarter, year, etc.).

The inventors have further recognized and appreciated that a local energy storage management system may have limited access to data. For instance, the local energy storage management system 160 may have access only to data collected from the energy application 120. Accordingly, in some embodiments, the local energy storage management system 160 may receive data from the remote energy storage management system 150. Any suitable data may be received from the remote energy storage management system 150, including, but not limited to, traffic information, weather information, and/or information collected from one or more other energy applications.

The local energy storage management system 160 may transmit data to, and/or receive data from, the remote energy storage management system 150 in any suitable manner. In some embodiments, the local energy storage management system 160 may transmit data to, and/or receive data from, the remote energy storage management system 150 in real time. For instance, the local energy storage management system 160 may use one or more wired and/or wireless networking technologies to transmit data to, and/or receive data from, the remote energy storage management system 150 periodically (e.g., every second, minute, five minutes, 10 minutes, etc.).

Additionally, or alternatively, the local energy storage management system 160 may transmit data to, and/or receive data from, the remote energy storage management system 150 in a batched fashion. For instance, the energy application 120 may include an electric vehicle, and the local energy storage management system 160 may transmit data to, and/or receive data from, the remote energy storage management system 150 when the energy application 120 is charging at a station.

In some embodiments, the local energy storage management system 160 may use one or more energy management strategies to analyze one or more inputs and output one or more control signals. The one or more energy management strategies may be selected dynamically. For instance, with reference to the example of FIG. 1A, an energy management strategy may be selected based on one or more conditions relating to the illustrative energy storage devices 110A-B and/or the illustrative energy application 120, and/or one or more environmental conditions.

Since the local energy storage management system 160 may have limited memory and/or processing cycles, the remote energy storage management system 150 may, in some embodiments, assist the local energy storage management system 160 in storing and/or selecting an appropriate energy management strategy. For instance, the remote energy storage management system 150 may store a collection of energy management strategies 154. Additionally, or alternatively, the remote energy storage management system 150 may include a classifier 156 configured to perform classification based on data received from the local energy storage management system 160.

In some embodiments, the local energy storage management system 160 may be configured to detect a change in one or more relevant conditions. As an example, the energy application 120 may include an electric vehicle, and the local energy storage management system 160 may be configured to detect a change in road conditions, for instance, by comparing one or more sensor measurements (e.g., slip coefficient, wheel vibration, etc.) against one or more respective thresholds. In response to detecting a change in road condition, the local energy storage management system 160 may send, to the remote energy storage management system 150, a request for an energy management strategy update.

In some embodiments, the strategy update request sent by the local energy storage management system 160 may include pertinent data, such as the one or more sensor measurements that triggered the strategy update request. The remote energy storage management system 150 may use this data to select an appropriate energy management strategy. Additionally, or alternatively, the remote energy storage management system 150 may use data retrieved from the data store 152 to select an appropriate energy management strategy.

For instance, the classifier 156 may include a machine learning model that maps two inputs, slip coefficient and wheel vibration, to a label indicative of a type of road condition (e.g., paving blocks, asphalt, concrete, dirt, etc.). The classifier 156 may apply such a machine learning model to the data received from the local energy storage management system 160 and/or the data retrieved from the data store 152. The remote energy storage management system 150 may use a label output by the classifier 156 to select an appropriate energy management strategy from the collection of energy management strategies 154. The remote energy storage management system 150 may then return the selected energy management strategy to the local energy storage management system 160.

Any suitable technique may be used to train a machine learning model for the classifier 156. For instance, in some embodiments, the machine learning model may include an artificial neural network, such as a convolutional neural network (CNN), a recurrent neural network (RNN) such as a long short-term memory (LSTM) neural network, etc. Labeled data (e.g., slip coefficient and wheel vibration measurements under known road conditions) may be used to train the artificial neural network. Additionally, or alternatively, an unsupervised learning technique (e.g., cluster analysis such as k-means clustering) may be used. Additionally, or alternatively, an ensemble learning technique (e.g., a random forest based on a plurality of decision trees) may be used.

It should be appreciated that aspects of the present disclosure are not limited to using a machine learning model with trained parameter values to select an appropriate energy management strategy. Additionally, or alternatively, other types of machine learning models may be used, such as reinforcement learning models (e.g., based on dynamic programming techniques).

Although details of implementation are described above and shown in FIG. 1B, it should be appreciated that aspects of the present disclosure are not limited to any particular manner of implementation. For instance, in some embodiments, multiple classifiers may be provided (e.g., for road conditions, traffic, weather, etc.). Appropriate program logic may be applied to the outputs of these classifiers to select an energy management strategy.

Additionally, or alternatively, a classifier may be provided at the local energy storage management system 160, and a classifier output may be sent to the remote energy storage management system 150 instead of, or in addition to, one or more raw measurements.

In some embodiments, the local energy storage management system 160 of the energy application 120 may share data with an energy storage management system of another energy application. For instance, the local energy storage management system 160 may receive data from, and/or send data to, the other energy storage management system through a communication channel established using one or more suitable networking technologies (e.g., 5G, WiMax, LTE, GSM, WiFi, Ethernet, Bluetooth, etc.).

In some embodiments, the local energy storage management system 160 may receive, from an energy storage management system of another energy application, data that may be used to evaluate system performance and/or predict future power demand. Examples of such data include, but are not limited to, current traffic conditions, cycle efficiencies, and/or states of health of energy storage devices. The local energy storage management system 160 may analyze the received data and decide whether to replace a currently deployed energy management strategy with another energy management strategy.

For instance, the local energy storage management system 160 may determine that the other energy application is experiencing environmental conditions that are similar to what the energy application 120 is likely to experience in the near future (e.g., upcoming traffic conditions), and the other energy application is performing well in those environmental conditions (e.g., cycle efficiencies and/or states of health above respective thresholds). Accordingly, the local energy storage management system 160 may decide to switch to an energy management strategy applied by the other energy application.

It should be appreciated that the local energy storage management system 160 may communicate with the other energy storage management system either directly or indirectly. For instance, the energy storage management systems may establish a direct communication channel. Additionally, or alternatively, the energy storage management systems may communicate through one or more intermediaries, such as the remote energy storage management system 150 in the example of FIG. 1B. For instance, the remote energy storage management system 150 may collect data from multiple energy applications (e.g., a fleet of vehicles), determine which energy applications are performing well and which are performing poorly, and decide whether to instruct a poor-performing energy application to switch an energy management strategy used by a well-performing energy application.

It should also be appreciated that aspects of the present disclosure are not limited to having both a remote energy storage management system and a local energy storage management system. In some embodiments, there may be only a local energy storage management system, only a remote energy storage management system, or neither.

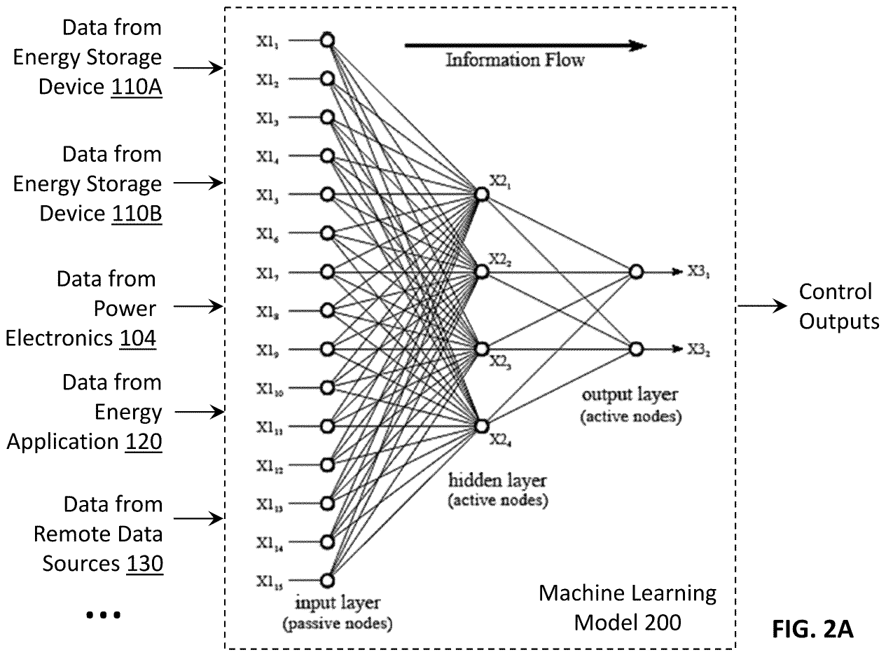

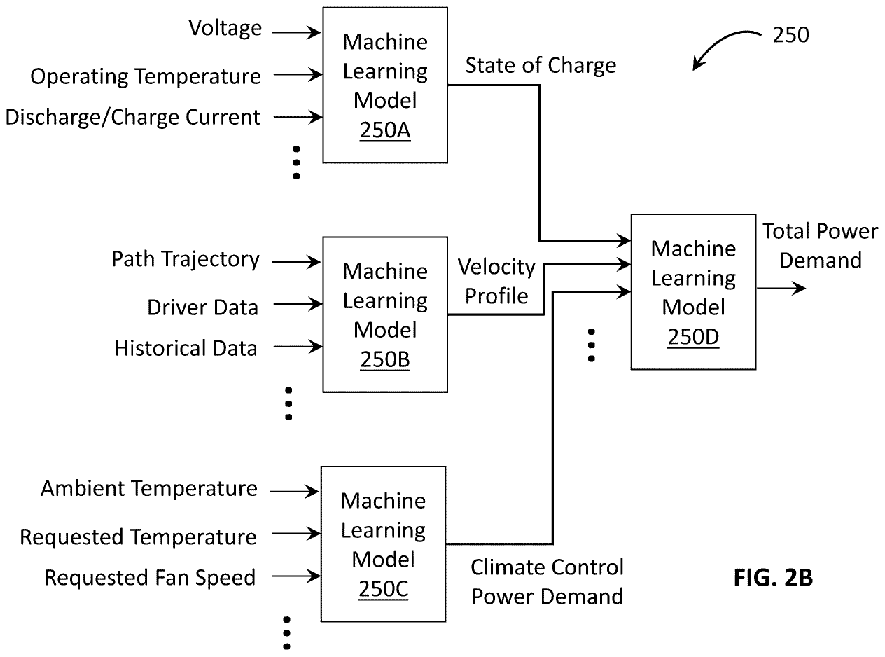

FIG. 2A shows an illustrative machine learning model 200, in accordance with some embodiments. The machine learning model 200 may be an energy management strategy that maps one or more inputs to one or more control outputs. (By contrast, the illustrative classifier 156 in the example of FIG. 1B may use a machine learning model that outputs one or more classification labels.)

In some embodiments, the machine learning model 200 may be part of the illustrative collection of energy management strategies 154 in the example of FIG. 1B. Additionally, or alternatively, the machine learning model 200 may be used by the illustrative controller 102 in the example of FIG. 1A to analyze one or more inputs and output one or more control signals.

In some embodiments, the one or more inputs of the machine learning model 200 may include data from the illustrative energy storage device 110A, the illustrative energy storage device 110B, the illustrative power electronics 104, the illustrative energy application 120, and/or the one or more illustrative remote data sources 130 in the example of FIG. 1A. Such data may be received dynamically. The controller 102 may use the machine learning model 200 to analyze the received data and provide one or more control signals accordingly. For instance, the controller 102 may provide a control signal to the power electronics 104 to indicate how a demand or supply of power by the energy application 120 should be distributed between the energy storage devices 110A and 110B.

In some embodiments, the energy storage devices 110A and 110B may include one or more electrochemical battery packs, and the data received from the energy storage devices 110A and 110B may include one or more of the following. (The abbreviation “ESS” stands for energy storage system.)

TABLE 1
Data for Electrochemical Battery

| Dependent Variable | Symbol | Independent Variables | Symbol |
|---|---|---|---|
| Energy Storage System | SoC_{ESS} | Voltage | V_{ESS} |
| State of Charge | | Operating Temperature | T_{ESS} |
| | | Discharge/Charge Current | I_{ESS} |
| Equivalent Energy Storage | ESR_{ESS} | Discharge/Charge Current | I_{ESS} |
| System Series Resistance | | Operating Temperature | T_{ESS} |
| | | Energy Storage System State of | SoH_{ESS} |
| | | Health | |
| Energy Storage System | SoH_{ESS} | Energy Storage System Maximum | E_{ESS}_{_{—}}_{Nominal}_{_{—}}_{Max} |
| State of Health Estimate | | Nominal Capacity | |
| | | Energy Storage System Maximum | E_{ESS}_{_{—}}_{Max} |
| | | Capacity¹ | |
| | | Energy Storage Average State of | SoC_{ESS}_{_{—}}_{Average} |
| | | Charge | |
| | | Number of Equivalent Full | N_{ESS} |
| | | Discharge Cycles | |
| | | Operating Temperature | T_{ESS} |

In some embodiments, the energy storage device 110n may include a supercapacitor, and the data received from the energy storage device 110B may include one or more of the following.

TABLE 2
Data for Supercapacitor

| Dependent Variable | Symbol | Independent Variables | Symbol |
|---|---|---|---|
| State of Charge | SoC_{ESS} | Voltage | V_{ESS} |
| | | Operating Temperature | T_{ESS} |
| | | Energy Storage System Capacitance | C_{ESS} |
| | | Discharge/Charge Current | I_{ESS} |
| Equivalent Energy Storage | ESR_{ESS} | Discharge/Charge Current | I_{ESS} |
| System Series Resistance | | Operating Temperature | T_{ESS} |
| | | Energy Storage System State of | SoH_{ESS} |
| | | Health | |
| Energy Storage System | SoH_{ESS} | Energy Storage System Maximum | E_{ESS}_{_{—}}_{Nominal}_{_{—}}_{Max} |
| State of Health Estimate | | Nominal Capacity | |
| | | Energy Storage System Maximum | E_{ESS}_{_{—}}_{Max} |
| | | Capacity | |
| | | Energy Storage System Capacitance | C_{ESS} |
| | | Energy Storage Average State of | SoC_{ESS}_{_{—}}_{Average} |
| | | Charge | |
| | | Number of Equivalent Full Discharge | N_{ESS} |
| | | Cycles | |
| | | Operating Temperature | T_{ESS} |

¹In some embodiments, maximum capacity for an energy storage device (e.g., battery, supercapacitor, etc.) may be modeled as a time-dependent function. For instance, maximum capacity may vary due to calendar aging, cyclical aging, etc. Additionally, or alternatively, a maximum capacity function may depend on one or more thermal conditions, one or more charge/discharge conditions, etc.

In some embodiments, the data received from the power electronics 104, the energy application 120, and/or the one or more remote data sources 130 may include general environmental data, such as one or more of the following.

TABLE 3A
General Environmental Data

| Data | Symbol | Unit |
|---|---|---|
| Temperature | T | C. |
| Humidity | RH | % |
| Atmospheric Pressure | atm | Atm |
| Wind Speed and/or Direction | V_{wind} | m/s |

In some embodiments, the energy application 120 may include a vehicle, and the data received from the power electronics 104, the energy application 120, and/or the one or more remote data sources 130 may include vehicle environmental data, such as one or more of the following.

TABLE 3B
Vehicle Environmental Data

| Dependent Variable | Category | Independent Variables |
|---|---|---|
| Vehicle Predicted | Path Trajectory | GPS Coordinates |
| Velocity Profile | | Road Slope |
| | | Speed Limit associated with Path Trajectory |
| | Sensor & Relational | Proximity to Co-Directional Vehicle(s) |
| | Data | Velocity of Co-Directional Vehicle(s) |
| | | Road Surface Classification |
| | Historical Data | Historical Path Trajectory Data associated with |
| | | Active Path Trajectory |
| Vehicle Predicted | Climate Control | Ambient Temperature of Operating Environment |
| Auxiliary Power | Energy Demand | Absorption, Radiation and Transmission (ART) |
| Demand | | Ratio of Cabin² |
| | | Geospatial Insolation Angle |
| | Energy Storage | Ambient Temperature |
| | Active Thermal | |
| | Management | |

²In some embodiments, ART ratio may be modeled as a time-dependent function. For instance, ART ratio may vary due to aging of cabin glass, changing weather, etc. Additionally, or alternatively, ART ratio may vary depending on time of day, time of year, etc. Accordingly, ART ratio may have large fluctuations throughout useful life of a vehicle, but may have small fluctuations within a single drive cycle.

In some embodiments, one or more of the dependent variables and/or independent variables shown in Table 3B may be used to predict vehicle power demand.

In some embodiments, the energy application 120 may include an electric grid, and the data received from the power electronics 104, the energy application 120, and/or the one or more remote data sources 130 may include electric grid environmental data, such as one or more of the following.

TABLE 3C
Electric Grid Environmental Data

| Dependent Variable | Category | Independent Variables |
|---|---|---|
| Power Generation Forecast | Weather | Wind Speed [m/s] |
| | | Air Density [atm] |
| | | Solar Radiation [kW/m²] |

In some embodiments, one or more of the dependent variables and/or independent variables shown in Table 3C may be used to predict power generation (e.g., by wind turbines and/or solar panels) and/or power demand.

In some embodiments, the data received from the power electronics 104, the energy application 120, and/or the one or more remote data sources 130 may include general operational data, such as one or more of the following.

TABLE 4A
General Operational Data

| Data | Symbol | Unit |
|---|---|---|
| Power | P | kW |
| Current | i | Ampere |
| Energy efficiency | η | N/A |

In some embodiments, the energy application 120 may include a vehicle, and the data received from the power electronics 104, the energy application 120, and/or the one or more remote data sources 130 may include vehicle operational data, such as one or more of the following.

TABLE 4B
Vehicle Operational Data

| Dependent Variable | Category | Independent Variables |
|---|---|---|
| Vehicle Predicted | Pilot Data | Torque Demand |
| Velocity Profile | | Brake Position Sensor Data |
| | Historical Data | Historical Pilot Data associated with Active Path |
| | | Trajectory |
| | Vehicle Kinematics | Total Vehicle Chassis and Passenger/Payload |
| | | Mass |
| | | Road Load Coefficients (F₀, F₁, F₂) |
| | | Powertrain Efficiency |
| | | Regenerative Braking Efficiency |
| | | Power Electronics Efficiency |
| Vehicle Predicted | Climate Control | Driver Requested Temperature |
| Auxiliary Power | Energy Demand | Driver Requested Fan Speed |
| Demand | | Cabin Window Position Sensor Data |
| | | Driver Requested Airflow Channel |
| | Transmission & | Transmission Rotational Velocity |
| | Powertrain Fluid | Transmission Oil Viscosity |
| | Pump Demand | Transmission Oil Temperature |
| | | Spin Loss |
| | Vehicle Operational | Brake-by-wire system power demand |
| | Losses | Steer-by-wire system power demand |
| | Energy Storage | Energy Storage System Heat Generation |
| | Active Thermal | Energy Storage System Operating Temperature |
| | Management | Range |
| | | Energy Storage System Measured Temperature |

In some embodiments, one or more of the dependent variables and/or independent variables shown in Table 4B may be used to predict vehicle power demand.

In some embodiments, the energy application 120 may include an electric grid, and the data received from the power electronics 104, the energy application 120, and/or the one or more remote data sources 130 may include electric grid operational data, such as one or more of the following.

TABLE 4C
Electric Grid Operational Data

| Dependent | | |
|---|---|---|
| Variable | Category | Independent Variables |
| Power | General | Generation Type (e.g., |
| Generation | | Photovoltaic, Wind, etc.) |
| Forecast | | System Capacity |
| | | Power Electronics Losses |
| | | Transmission & Wiring |
| | | Losses |
| | Photovoltaic | Photovoltaic Panel Efficiency |
| | | Array Azimuth [°] |
| | | Array Tilt [°] |
| | Wind | Betz Limit [] |
| | | Blade Radius [m] |
| | | Tip Speed Ratio [] |
| Power | Sensor & Historical | Forecast by Independent |
| Demand | Data | System Operator (ISO) or |
| Forecast | | other Organization |
| | | Instantaneous Power Demand |
| | | Historical Power Demand |

In some embodiments, one or more of the dependent variables and/or independent variables shown in Table 4C may be used to predict power generation (e.g., by wind turbines and/or solar panels) and/or power demand.

It should be appreciated that the above examples of dynamic data are provided solely for purposes of illustration, as aspects of the present disclosure are not limited to using any particular type or combination of dynamic data, or any dynamic data at all. For instance, although vehicle and electric grid are described above, it should be appreciated that the techniques described herein may be used to manage energy storage systems for any type of energy application.

As described above in connection with the example of FIG. 1A, the controller 102 may provide one or more control signals indicative of a power distribution. For instance, the one or more control signals may indicate a percentage of power to be drawn from, or supplied to, the energy storage device 110A, and/or a percentage of power to be drawn from, or supplied to, the energy storage device 110B. In some embodiments, this power distribution may be effectuated by the power electronics 104 during a next control cycle. Additionally, or alternatively, power distribution may be updated one or more times during a control cycle.

In some instances, power may be drawn from both the energy storage device 110A and the energy storage device 110B, and the one or more control signals may indicate how an overall power demand is split between these two energy storage devices. In some instances, power may be supplied to both the energy storage device 110A and the energy storage device 110B, and the one or more control signals may indicate how an overall power supply is split between these two energy storage devices.

In some embodiments, the controller 102 may sometimes output a power distribution where a first amount of power is to be drawn from the energy storage device 110A, but a second amount of power is to be supplied to the energy storage device 110B. Additionally, or alternatively, the controller 102 may sometimes output a power distribution where a first amount of power is to be supplied to the energy storage device 110A, but a second amount of power is to be drawn from the energy storage device 110B. A difference between the first amount and the second amount may indicate an amount of power drawn from, or supplied to, the energy application 120.

As an example, if the energy application 120 is drawing power, the one or more control signals may indicate how an amount of power drawn from one energy storage device is split between the energy application 120 and the other energy storage device. Similarly, if the energy application 120 is supplying power, the one or more control signals may indicate how an amount of power supplied to one energy storage device is split between the energy application 120 and the other energy storage device.

The inventors have recognized and appreciated that it may be desirable to provide updates in power distribution based on newly collected data. For instance, power distribution may be updated based on one or more objectives, such as improving lifetime of energy storage devices, improving energy efficiency (e.g., extending range of an electric vehicle), etc. Therefore, shorter control cycles may be beneficial. However, control cycles that are too short may lead to rapid power fluctuations, which may in turn cause damage to power electronics, electric motors, etc.

Accordingly, in some embodiments, a duration of a control cycle may be selected that represents a desired tradeoff. For instance, a control cycle may last several seconds (e.g., 5 seconds, 10 seconds, 20 seconds, 30 seconds, 40 seconds, 50 seconds, 60 seconds, . . . ) or several minutes (e.g., 2 minutes, 3 minutes, 4 minutes, 5 minutes, 6 minutes, 7 minutes, 8 minutes, 9 minutes, 10 minutes, . . . ).

In some embodiments, data that is used by the controller 102 to make control decisions may be acquired at a frequency that is the same as, or different from, a frequency at which power distribution is updated. For instance, a power distribution update frequency (e.g., every second) may be a multiple of a data acquisition frequency (e.g., every millisecond), so that multiple data points may be collected during a control cycle. A suitable statistic (e.g., mean, median, mode, maximum, minimum, etc.) of the data points may be used to determine an appropriate power distribution to be effectuated during a next control cycle.

In some embodiments, one or more machine learning techniques may be used to determine an appropriate power distribution. For instance, the machine learning model 200 in the example of FIG. 2A may include an artificial neural network with an input layer, one or more hidden layers, and an output layer. In some embodiments, the artificial neural network may be a multilayer perceptron network, although that is not required. Aspects of the present disclosure are not limited to using any particular type of artificial neural network, or any artificial neural network at all.

For instance, in some embodiments, a CNN may be used, with one or more convolutional layers and/or pooling layers for feature learning, followed by one or more fully-connected layers for classification or regression. Additionally, or alternatively, an RNN may be used, such as an LSTM neural network.

Any suitable technique may be used to train the machine learning model 200. For instance, in some embodiments, the machine learning model 200 may be trained using labeled data under a supervised learning technique. Additionally, or alternatively, an unsupervised learning technique (e.g., cluster analysis such as k-means clustering) may be used. Additionally, or alternatively, an ensemble learning technique (e.g., a random forest based on a plurality of decision trees) may be used.

It should be appreciated that aspects of the present disclosure are not limited to using a machine learning model with trained parameter values. Additionally, or alternatively, other types of machine learning models may be used, such as reinforcement learning models (e.g., based on dynamic programming techniques).

The inventors have recognized and appreciated that, in some instances, it may be beneficial to use a set of machine learning models, as opposed to a single machine learning model. For instance, a machine learning model with a large number of input nodes may be replaced by a set of machine learning models each having a small number of input nodes. These machine learning models may be trained separately, thereby reducing computation complexity.

FIG. 2B shows an illustrative set of machine learning models 250, in accordance with some embodiments. For instance, machine learning models 250A, 250B, 250C, 250D, etc., collectively, may be used by the illustrative controller 102 in the example of FIG. 1A to map one or more inputs to one or more control outputs.

In some embodiments, the machine learning models 250A, 250B, 250C, 250D, etc. may be connected in a suitable manner. For instance, the machine learning model 250D may be configured to generate an output based on a plurality of inputs, where some of the inputs are output by the machine learning models 250A, 250B, and 250C. Thus, some of the models (e.g., 250A and 250D) may be in series, while others (e.g., 250A, 250B, and 250C) may be in parallel.

In the example shown in FIG. 2B, the machine learning model 250D may be configured to estimate a total power demand of an electric vehicle. The machine learning model 250D may receive current conditions of one or more energy storage devices in the electric vehicle, kinetic characteristics of the electric vehicle, expected velocity profile of the electric vehicle, expected power loses in one or more auxiliary systems, and/or one or more other inputs.

For instance, the machine learning model 250D may receive, from the machine learning model 250A, an estimated state of charge for one of the energy storage devices. The machine learning model 250A may in turn receive voltage, operating temperature, discharge/charge current, and/or one or more other inputs.

Additionally, or alternatively, the machine learning model 250D may receive, from the machine learning model 250B, an expected velocity profile for an electric vehicle. The machine learning model 250B may in turn receive path trajectory, driver data, historical data, and/or one or more other inputs.

Additionally, or alternatively, the machine learning model 250D may receive, from the machine learning model 250C, an expected power demand for a climate control auxiliary system. The machine learning model 250C may in turn receive ambient temperature, requested temperature, requested fan speed, and/or one or more other inputs.

It should be appreciated that the various inputs and outputs described above and shown in FIG. 2B are provided solely for purposes of illustration. Aspects of the present disclosure are not limited to using a machine learning model with any particular input or combination of inputs, or any particular output or combination of outputs. Aspects of the present disclosure are also not limited to using a set of machine learning models arranged in any particular manner, or any machine learning model at all. For instance, in some embodiments, only one machine learning model may be used, such as the machine learning model 250A.

In some embodiments, each of the machine learning models 250A, 250B, 250C, 250D, etc. may include an artificial neural network, or a model of some other type. Such a model may have any suitable architecture, which may be similar to, or different from, that of the illustrative machine learning model 200 in the example of FIG. 2A.

For instance, the machine learning model 250C may include an artificial neural network that is trained to estimate power demand for a climate control auxiliary system (e.g., driver cabin HVAC) based on one or more of the following inputs.
Driver requested temperature
Driver requested fan speed
Driver requested air channel flow (e.g., whether to have air circulated within the cabin only, or to allow fresh air from outside)
Driver requested seat and/or steering wheel heating
Number of occupants
Ambient temperature
Heat input to cabin due to solar radiation (e.g., estimated based on weather, time of day, time of year, latitude, heading, etc.)
Cabin HVAC usage history (e.g., all of the above inputs and corresponding output) for the same time of day for the same range of driver requested temperature.

In some embodiments, a fully-connected neural network may be used to determine a cabin HVAC power demand based on one or more of the above inputs and/or one or more other inputs. The neural network may have an input layer with any suitable number of nodes. For instance, there may be one input node for each of the above inputs, or there may be more or fewer input nodes.

In some embodiments, the neural network may have at least one hidden layer. Such a hidden layer may have as many nodes as the input layer, or fewer nodes, depending on desired levels of accuracy, computation efficiency, etc.

Any suitable type of activation function may be used for the neural network, including, but not limited to, sigmoid, rectified linear unit (ReLU), etc. The activation function may be selected in any suitable manner, for example, depending on a depth of the neural network.

In some embodiments, the neural network may have an output node for cabin HVAC power demand. Additionally, or alternatively, the output node may include other information (e.g., cabin temperature to be attained, rate of change of cabin temperature, etc.). Such information may be provided for monitoring and/or feedback.

In some embodiments, a long short-term memory (LSTM) neural network may be used instead of, or in addition to, a feedforward neural network. One or more outputs of the LSTM neural network (e.g., cabin HVAC power demand, cabin temperature to be attained, rate of change of cabin temperature, etc.) may be fed back into the LSTM neural network to establish a time series of recent history, which may improve forecasting accuracy.

It should be appreciated that one or more of the neural network techniques described above, and/or one or more other neural network techniques, may be used to estimate any suitable dependent variable in addition to, or instead of cabin HVAC power demand. For instance, one or more of the neural network techniques described above, and/or one or more other neural network techniques, may be used to estimate velocity profile (e.g., by the machine learning model 250B), energy storage operating temperature, energy storage state of charge (e.g., by the machine learning model 250A), etc.

Additionally, or alternatively, one or more of the neural network techniques described above, and/or one or more other neural network techniques, may be used to determine a power distribution among multiple energy storage devices (e.g., the illustrative energy storage devices 110A-B in the example of FIG. 1A).

In some embodiments, a neural network may be trained using labeled data. Such labeled data may be created for a given neural network by collecting data through testing and/or simulation, and annotating the collected data. With respect to the example in FIG. 2B, training data for the machine learning model 250B may be labeled based on velocity ranges (e.g., “10-15 mph,” “15-20 mph,” etc. for each road segment in a route).

The inventors have recognized and appreciated that certain limits (e.g., maximum instantaneous charge/discharge current, maximum/minimum operating temperature, etc.), if violated, may cause damage to an energy storage system. Accordingly, in some embodiments, program logic may be provided to analyze an output of a neural network. For example, if a neural network outputs a discharge current for an energy storage device that exceeds a maximum instantaneous discharge current for that device, that output may not be fed into another component of an energy storage management system (e.g., another neural network). Additionally, or alternatively, the output may be flagged as impossible and/or replaced by the maximum instantaneous discharge current.

In some embodiments, weights and/or biases of a neural network may be trained initially using data from testing and/or simulation. For instance, weights and/or biases for a neural network for estimating a dependent variable relating to an energy storage device may be trained on data obtained from experiments conducted on the energy storage device and/or computer simulations that apply relevant load profiles to one or more models of the energy storage device (e.g., one or more physics-informed models). After such initial training, the neural network may be deployed to analyze data obtained during operation of an energy application.

In some embodiments, data obtained during operation of an energy application may be used to update one or more physics-informed models. Additionally, or alternatively, an updated physics-informed model may be used to generate simulation data, which may in turn be used to retrain a neural network.

It should be appreciated that any one or more suitable methods may be used to train a neural network, as aspects of the present disclosure are not so limited. Examples of training methods include, but are not limited to, gradient descent, Newton, conjugate gradient, quasi-Newton, and/or Levenberg-Marquardt.

The inventors have recognized and appreciated that, in some instances, training data relevant for a particular deployment scenario may initially be unavailable. As one example, labeled data may not be available for a new Li-NMC battery. Nevertheless, a neural network for estimating state of charge (e.g., the machine learning model 250A) may be trained on available labeled data for a Li-NCA battery, and may be deployed for the Li-NMC battery.

In some embodiments, retraining may be performed as labeled data for the Li-NMC battery becomes available. For instance, relevant measurements (e.g., voltage, current, temperature, etc.) may be taken as the Li-NMC battery is used, and may be used to update a physics-informed model for the Li-NMC battery. The updated physics-informed model may be used to generate simulation data, which may in turn be used to retrain the neural network for estimating state of charge.

As another example, labeled data from actual drive cycles may not be available for a new vehicle. Nevertheless, a neural network for estimating velocity profile (e.g., the machine learning model 250B) may be trained on available labeled data from standard emission testing (e.g., US EPA FTP-75 urban and highway combined drive cycle). For instance, a neural network may be trained on standard emission testing data to predict a velocity for a next time point given a velocity profile over one or more previous time points. Such predictions may be made at any suitable frequency, such as every sec, every 5 sec, every 10 sec, etc.

In some embodiments, retraining may be performed as labeled data from actual drive cycles becomes available. For instance, a velocity profile may be recorded as the vehicle is driven, and the recorded velocity profile (along with corresponding inputs) may be used for retraining.

Although an electric vehicle is described above in connection with the example of FIG. 2B, it should be appreciated that aspects of the present disclosure are not limited to any particular type of energy application. In some embodiments, a machine learning model may be provided to estimate a computation profile for a data center, which may in turn be used to estimate the data center's total power demand.

The inventors have recognized and appreciated that, while a machine learning model may be deployed in a resource-constrained environment (e.g., an embedded processor in an electric vehicle), it may be beneficial to use a computing system with more resources (e.g., a cloud server) to perform one or more resource intensive tasks such as retraining of the machine learning model. Data for use in such a task may be transmitted by the embedded processor to the cloud server (e.g., via the illustrative network interface 106 in the example of FIG. 1A), and updated software may be transmitted by the cloud server back to the embedded processor (e.g., again via the network interface 106).

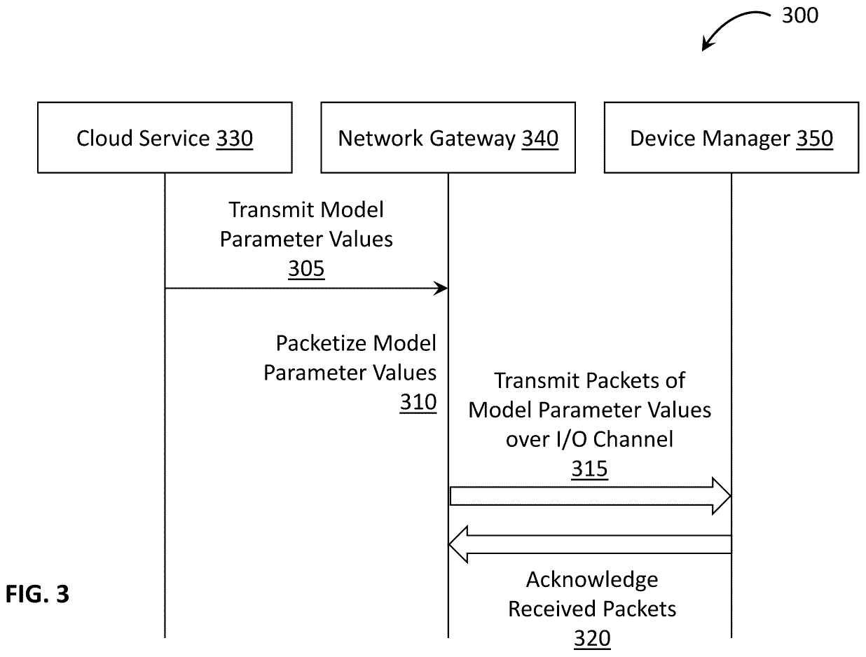

FIG. 3 shows an illustrative process 300 for updating energy storage management software, in accordance with some embodiments. For instance, the process 300 may be used for a resource-constrained environment such as an embedded processor.

In the example of FIG. 3, a cloud service 330, a network gateway 340, and a device manager 350 participate in the process 300. The cloud service 330 may be provided by the illustrative remote energy storage management system 150 in the example of FIG. 1B. The network gateway 340 may be provided by the illustrative energy storage management system 100 in the example of FIG. 1A (which may be part of the local energy storage management system 160 in the example of FIG. 1). The device manager 350 may be the illustrative device manager 114A or 114B in the example of FIG. 1A.

In some embodiments, the device manager 350 may not have a direct network connection to the cloud service 330. Therefore, updated software may be received first by the network gateway 340, which may establish a connection with the cloud server 330 using any suitable networking technology (e.g., 5G, WiMax, LTE, GSM, WiFi, Ethernet, Bluetooth, etc.). The network gateway 340 may then forward the received updated software to the device manager 350.

The inventors have recognized and appreciated that energy storage management software may be in use continuously by the device manager 350 when an energy application is in operation. Therefore, instead of writing over an existing version of the software in memory in communication with the device manager 350, additional memory space may be allocated to store an updated version (e.g., an entire model, one or more model parameters, etc.) that is being received.

The inventors have further recognized and appreciated that the device manager 350 may run on an embedded processor, and therefore memory may be a scarce resource. Accordingly, in some embodiments, only a portion of the energy storage management software may be updated. For instance, one or more machine learning models within the software may be updated, instead of the entire software.

In some embodiments, if a new model has the same architecture as an existing model, only one or more parameter values may be updated, instead of the entire model. For instance, in the example of FIG. 3, the cloud service 330 may be configured to retrain a neural network model, thereby obtaining one or more new model parameter values as one or more weights and/or biases. The cloud service 330 may, at act 305, transmit the one or more new weights and/or biases to the network gateway 340.

In some embodiments, the network gateway 340 and the device manager 350 may communicate with each other via an I/O channel, which may have a limited bandwidth. Accordingly, at act 310, the network gateway 340 may packetize, based on available bandwidth, the one or more new weights and/or biases received from the cloud service 330.

The I/O channel may be implemented in any suitable manner. For instance, in some embodiments, the I/O channel may include a CAN bus. Additionally, or alternatively, the I/O channel may include a local interconnect network (LIN) bus. Additionally, or alternatively, the I/O channel may include a serial port interface. Additionally, or alternatively, the I/O channel may include a local area network (LAN) interface, such as Ethernet, WiFi, etc. Additionally, or alternatively, the I/O channel may include a personal area network (PAN) interface, such as Bluetooth.

For example, a data communication protocol (e.g., CAN FD) may be used that allows transmission of 64-byte data frames. Each data frame may include a payload field and/or one or more other fields. In some embodiments, the payload field may be 48 bytes long. Accordingly, the network gateway may break up the one or more new weights and/or biases received from the cloud service into 48-byte chunks. However, it should be appreciated that aspects of the present disclosure are not limited to any particular data frame size or payload size.

In some embodiments, the network gateway 340 may assemble payload chunks into respective data frames to be transmitted to the device manager 350 via a CAN bus. Additionally, or alternatively, in response to receiving a data frame with a payload chunk, the device manager 350 may send a data frame with an acknowledgment back to the network gateway 340.

In some embodiments, each data frame may have one or more of the following fields.
1) Sequence number
   a. This field may store an integer value, and may be 4 bytes long.
   b. For instance, the network gateway may assign a respective sequence number to each payload chunk within the same update. These sequence numbers may allow the device manager to stitch the received payload chunks together appropriately, to recover the one or more new weights and/or biases received from the cloud service.
2) Acknowledgement
   a. This field may store an integer value, and may be 4 bytes long.
   b. For instance, in response to receiving a data frame from the network gateway with an integer N in the sequence number field, the device manager may send a data frame to the network gate with N+1 in the acknowledgment field. This may indicate that N payload chunks have been received by the device manager, and a payload chunk with sequence number N+1 is expected next.
3) Frame type
   a. This field may store an integer value, and may be 4 bytes long.
   b. For instance, this field may store either a default value (e.g., 1) or a selected value (e.g., 2) that indicates a final payload chunk in a sequence of payload chunks for an update. Thus, in response to receiving a data frame with the selected value (e.g., 2) in this field, with no prior sequency number missing, the device manager may determine that the update has been received completely.
4) Frame size
   a. This field may store an integer value, and may be 4 bytes long.
   b. This field may be used by a receiving device to determine how much payload data to extract from a data frame, and/or how much memory to allocate for storing the extracted payload data. For instance, a data frame (e.g., acknowledgment only) may have no payload. Additionally, or alternatively, a final payload chunk in a sequence of payload chunks may be smaller than a non-final payload chunk.
5) Payload
   a. This field may store one or more floating point values, and may be 48 bytes long.
   b. For instance, this field may store up to 12 single precision floating point values (each of which may be 4 bytes long), and/or up to 6 double precision floating point values (each of which may be 8 bytes long).

In some embodiments, one or more error detection mechanisms may be used to ensure that a data frame hasn't been corrupted during transmission. Any suitable error detection mechanism may be used, such as a checksum function (e.g., a cyclic redundancy check). Such a mechanism may be provided by, or implemented on top of, an underlying data communication protocol (e.g., CAN FD).

Referring again to FIG. 3, the network gateway may, at act 315, transmit the data frames constructed at act 310 to the device manager via the CAN bus. At act 320, the device manager may transmit acknowledgments back to the network gateway.

In some embodiments, after transmitting a data frame, the network gateway may wait for a selected amount of time. If no acknowledgment is received from the device manager for that data frame, the network gateway may re-transmit the data frame.

Additionally, one or more packets transmitted from the network gateway 340 to the device manager 350 may be provided out of order and/or one or more packets may be lost during the transmission. The device manager 350 may be configured to reassemble the received packets in order into a software update package after receiving all of the packets. When a lost packet is detected, the device manager 350 may send a request for the lost packet to the network gateway 340 to resend the packet. In some embodiments, the software update package may be verified or “validated” after receiving all of the packets for the update package. For example, a checksum technique may be used to validate the software update package and the update may be discarded if the validation fails or if all of the expected packets for the update package are not received. In some embodiments, when validation fails and/or all packets for the update are not received, a model update routine may be exited and no instances of the inference model stored in memory may be updated.

The inventors have recognized and appreciated that consumption of resources such as memory, processor cycles, network bandwidth, etc. may be reduced by transmitting only new model parameter values. This approach may be used for any machine learning architecture where retraining only affects parameter values.

However, it should be appreciated that aspects of the present disclosure are not limited to updating model parameters only. In some embodiments, both parameter values and executable code that operates on the parameter values may be transmitted from the cloud service to the device manager (e.g., via the network gateway).

Although details of implementation are described above and shown in FIG. 3, it should be appreciated that aspects of the present disclosure are not limited to any particular manner of implementation. For instance, in some embodiments, the frame type field may store a Boolean value, instead of an integer value. The value 0 may indicate a non-final payload chunk, whereas the value 1 may indicate a final payload chunk, or vice versa.

In some embodiments, updated software (e.g., updated parameter values of a machine learning model) may be compressed and/or encrypted for transmission from the cloud service to the network gateway. Thus, the network gateway may decrypt and/or decompress the updated software prior to packetizing the updated software for transmission via the CAN bus to the device manager.

Additionally, or alternatively, measurement data (e.g., voltage, current, temperature, etc.) may be compressed and/or encrypted by the network gateway for transmission to the cloud service. Thus, the cloud service may decrypt and/or decompress the measurement data prior to using such data to update a physics-informed model and/or retrain a machine learning model.

In some embodiments, updated software may be pushed by the cloud service to the network gateway. However, it should be appreciated that aspects of the present disclosure are not so limited. In some embodiments, updated software may be pulled by the network gateway from the cloud service, in addition to, or instead of, being pushed by the cloud service to the network gateway.

In some embodiments, to receive services such as machine learning model retraining, the network gateway may register with the cloud service. Authentication credentials (e.g., certificates with corresponding public-private key pairs) may be established during registration, so that the cloud service may authenticate the network gateway, and/or vice versa.

However, it should be appreciated that aspects of the present disclosure are not limited to using a cloud service to perform model retraining. In some embodiments, model retraining may be performed on a local device with sufficient computational resources. Such a local device may participate in acts 310, 315, and 320 with the device manager.

Moreover, it should be appreciated that aspects of the present disclosure are not limited to performing acts 305, 310, 315, and 320 in immediate succession. In some embodiments, the network gateway (or a device performing model retraining locally) may determine an appropriate timing for packetizing and/or transmitting updated software. For instance, updated software may be packetized and/or transmitted in response to one or more triggers based on one or more conditions of an energy storage managed by the device manager, one or more conditions of an energy application drawing energy from (and/or supplying energy to) the energy storage, one or more environmental conditions, etc.

As discussed above, energy storage management software may be in use continuously by a device manager (e.g., device manager 350) when an energy application is in operation. The inventors have recognized and appreciated that it may be undesirable to write over existing software in memory while updated software is being received. For instance, if updated parameter values of a machine learning model are written into memory over existing parameter values as the updated parameter values are being received, there may be moments in time when a mix of existing and updated parameter values are used to make inferences, which may lead to inaccurate results.

Accordingly, in some embodiments, additional memory space may be allocated to store updated software that is being received, so that existing software may be undisturbed while it is being used by the device manager.

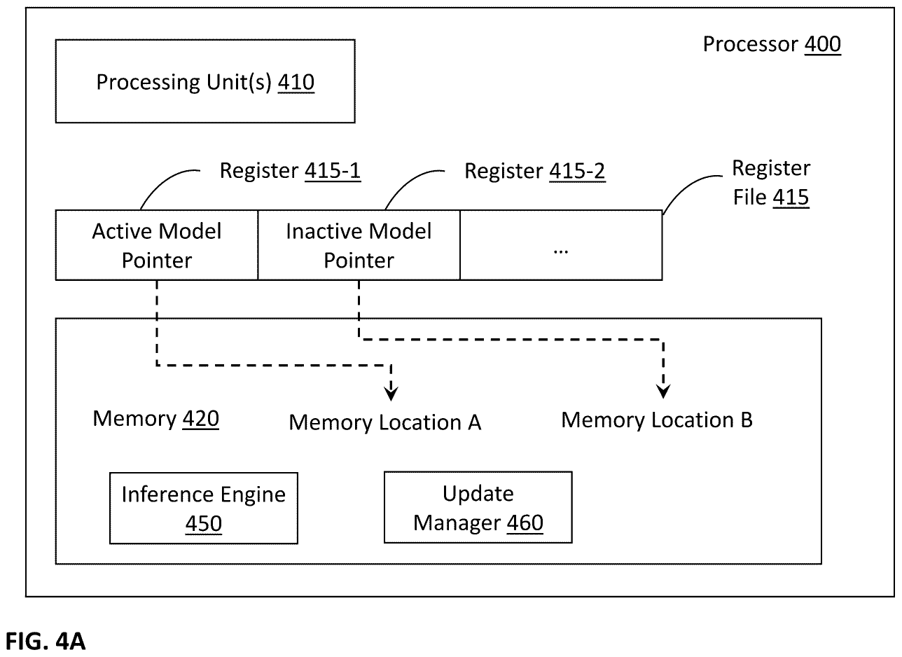

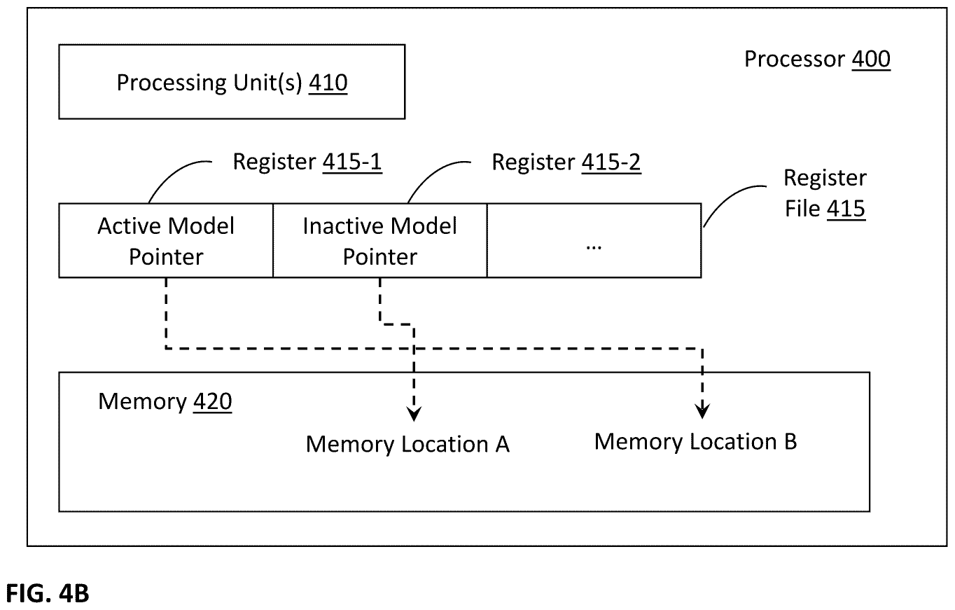

FIGS. 4A-B show an illustrative processor 400, in accordance with some embodiments. For instance, the illustrative device manager in the example of FIG. 3 (which may be the illustrative device manager 114A or 114B in the example of FIG. 1A) may run on the processor 400.

In some embodiments, the processor 400 may be a microcontroller embedded into a smart battery pack. However, it should be appreciated that aspects of the present disclosure are not so limited.

In the example of FIGS. 4A-B, the processor 400 includes one or more processing units 410 (e.g., an arithmetic logic unit, a control unit, etc.), a register file 415, and a memory 420. The memory 420 may store energy storage management software to be executed by the one or more processing units 410, as well as data manipulated by such software.

In some embodiments, the register file 415 may include one or more address registers, such as registers 415-1 and 415-2. The register 415-1 may store a pointer to a memory location where parameter values of a machine learning model are stored (e.g., weights and/or biases of a neural network model). For instance, the energy storage management software may include an inference engine 450 (executed by the one or more processing units 410), which may use a pointer stored in the register 415-1 to access existing parameter values from the memory 420, and may use the accessed parameter values to perform inference tasks (e.g., estimating SoH, SoC, etc. of an associated energy storage). Alternatively, inference engine 450 may access a value stored in a register when the energy storage management software is loaded for execution (or at any other suitable time), wherein the value in the register indicates whether to use the parameter values stored in memory location A or the parameters stored in memory location B. For instance, the register may store a value of “0” if the parameter values stored in memory location A should be used and store a value of “1” if the parameter values stored in memory location B should be used.

Additionally, or alternatively, the energy storage management software may include an update manager 460 (executed by the one or more processing units 410), which may use a pointer stored in the register 415-2 to write parameter values newly received, directly or indirectly, from a cloud service (e.g., as described in connection with the example of FIG. 3).

In the example of FIG. 4A, a pointer stored in the register 415-1 may point to a memory location A, and a pointer stored in the register 415-2 may point to a memory location B. Thus, the inference engine 450 may access existing parameter values from the memory location A, whereas the update manager 460 may write newly received parameter values to the memory location B.

In some embodiments, when the update manager 460 receives an indication that new data is received, update manager 460 may determine (e.g., by accessing a register) which set of parameter values are currently being used by the inference engine 450 such that the received data can be written to the memory location associated with the set of parameter values that are not currently in use.

In some embodiments, in response to determining that an update has been received completely, the update manager 460 may so inform the inference engine 450. For instance, the update manager 460 may pass the pointer to the memory location B to the inference engine 450, which may store that pointer in the register 415-1. Alternatively, if a register is being used to store the state of which set of parameters is currently being used by inference engine 450, update manager 460 may be configured to change the value stored in the register (e.g., from 0 to 1 or 1 to 0) after an update has been received completely. By changing the value stored in the register, the updated set of parameters may be used by the inference engine 450 when the inference engine 450 next checks the value stored in the register (e.g., upon loading the software for execution, when performing a next inference, in response to a change in a control state of the energy application, etc.). In this way, the update manager 460 may not be required to directly inform the inference engine 450 about the updated set of parameters being available.

In the example shown in FIG. 4B, the pointer stored in the register 415-1 may point to the memory location B, instead of the memory location A. Accordingly, when performing a next inference task, the inference engine 450 may load parameter values from the memory location B.

In some embodiments, when the inference engine 450 has replaced the pointer to the memory location A with the pointer to the memory location B, the inference engine 450 may so inform the update manager 460. Alternatively, in embodiments that change the state of a register to reflect the set of parameters for the inference engine 450 to use, no such communication between the inference engine 450 and the update manager 460 may be required.

In response, the update manager may store the pointer to the memory location A in the register 415-2. Thus, in the example shown in FIG. 4B, the pointer stored in the register 415-2 may point to the memory location A, instead of the memory location B. Accordingly, when a next update is received, the update manager may write new parameter values to the memory location A.

In some embodiments, when the next update is completed, a mirrored version of the above-described process may be performed to cause the inference engine to access parameter values from the memory location A again. Such a process (e.g., from the memory location A to the memory location B, and back to the memory location A) may be repeated as additional updates are received.

Although details of implementation are described above and shown in FIGS. 4A-B, it should be appreciated that aspects of the present disclosure are not limited to any particular manner of implementation. For instance, aspects of the present disclosure are not limited to having just one memory location for storing newly received updated software. In some embodiments, multiple versions of updated software may be received, and may be stored at respective memory locations. Any suitable technique or combination of techniques (e.g., similar to one or more of the techniques described above in connection with the illustrative classifier 156 in the example of FIG. 1B) may be used to select a version of updated software, and a corresponding pointer may be stored into the register 415-1 for use by the inference engine.

Additionally, or alternatively, multiple models may be updated in parallel. For instance, the memory locations A and B may be used to store and update parameter values for a model for inferring SoH, while memory locations C and D (not shown in FIGS. 4A-B) may be used to store and update parameter values for a model for inferring SoC. The two models may be updated via parallel threads executing on the same processor core, or different processor cores.

Additionally, or alternatively, one or more of the illustrative machine learning models 250A-D in the example of FIG. 2B may be updated, where each model may have a respective set of two or more memory locations, as described above in connection with the example of FIGS. 4A-B.

Additionally, or alternatively, one or more of the functionalities described above in connection with the example of FIGS. 4A-B (e.g., one or more aspects of the energy storage management software) may be distributed in any suitable manner, for instance, between a controller (e.g., the illustrative controller 102 in the example of FIG. 1A) and a device manager (e.g., the illustrative device manager 114A or 114B in the example of FIG. 1A).

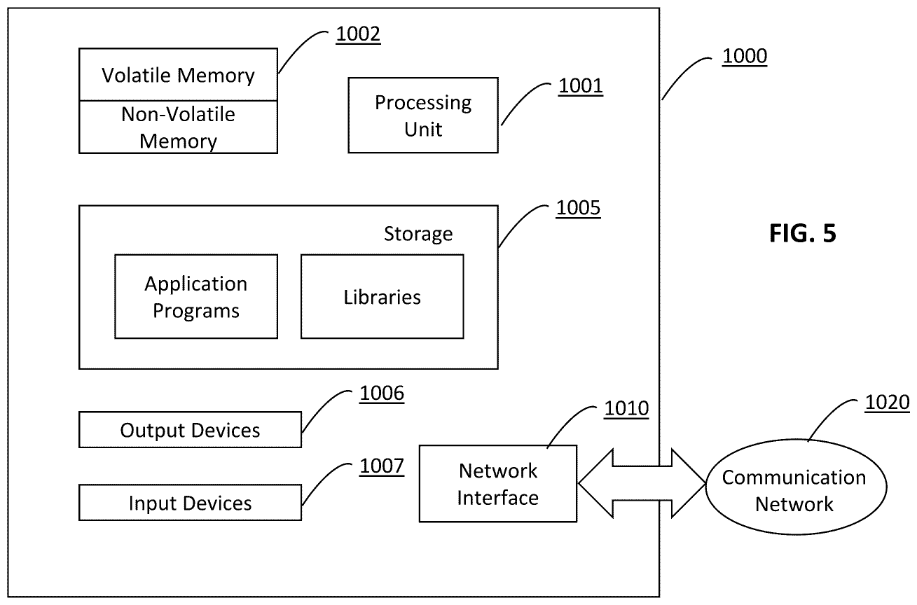

FIG. 5 shows, schematically, an illustrative computer 1000 on which any aspect of the present disclosure may be implemented.

In the example of FIG. 5, the computer 1000 includes a processing unit 1001 having one or more computer hardware processors and one or more articles of manufacture comprising at least one non-transitory computer-readable medium (e.g., a memory 1002 that may include, for example, volatile and/or non-volatile memory). The memory 1002 may store one or more instructions to program the processing unit 1001 to perform any of the functionalities described herein. The computer 1000 may also include other types of non-transitory computer-readable media, such as a storage 1005 (e.g., one or more disk drives) in addition to the memory 1002. The storage 1005 may also store one or more application programs and/or resources used by application programs (e.g., software libraries), which may be loaded into the memory 1002. Thus, the memory 1002 and/or the storage 1005 may serve as one or more non-transitory computer-readable media storing instructions for execution by the processing unit 1001.

The computer 1000 may have one or more input devices and/or output devices, such as devices 1006 and 1007 illustrated in FIG. 5. These devices may be used, for instance, to present a user interface. Examples of output devices that may be used to provide a user interface include printers, display screens, and other devices for visual output, speakers and other devices for audible output, braille displays and other devices for haptic output, etc. Examples of input devices that may be used for a user interface include keyboards, pointing devices (e.g., mice, touch pads, and digitizing tablets), microphones, etc. For instance, the input devices 1007 may include a microphone for capturing audio signals, and the output devices 1006 may include a display screen for visually rendering, and/or a speaker for audibly rendering, recognized text.

In the example of FIG. 5, the computer 1000 also includes one or more network interfaces (e.g., a network interface 1010) to enable communication via various networks (e.g., a network 1020). Examples of networks include local area networks (e.g., an enterprise network), wide area networks (e.g., the Internet), etc. Such networks may be based on any suitable technology operating according to any suitable protocol, and may include wireless networks and/or wired networks (e.g., fiber optic networks).

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing descriptions and drawings are by way of example only.

The above-described embodiments of the present disclosure can be implemented in any of numerous ways. For example, the embodiments may be implemented using hardware, software, or a combination thereof. When implemented in software, the software code may be executed on any suitable processor or collection of processors, whether provided in a single computer, or distributed among multiple computers.

Also, the various methods or processes outlined herein may be coded as software that is executable on one or more processors running any one of a variety of operating systems or platforms. Such software may be written using any of a number of suitable programming languages and/or programming tools, including scripting languages and/or scripting tools. In some instances, such software may be compiled as executable machine language code or intermediate code that is executed on a framework or virtual machine. Additionally, or alternatively, such software may be interpreted.

The techniques described herein may be embodied as a non-transitory computer-readable medium (or multiple such computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer-readable medium) encoded with one or more programs that, when executed on one or more processors, perform methods that implement the various embodiments of the present disclosure described above. The computer-readable medium or media may be portable, such that the program or programs stored thereon may be loaded onto one or more different computers or other processors to implement various aspects of the present disclosure as described above.

The terms “program” or “software” are used herein to refer to any type of computer code or set of computer-executable instructions that may be employed to program one or more processors to implement various aspects of the present disclosure as described above. Moreover, it should be appreciated that according to one aspect of this embodiment, one or more computer programs that, when executed, perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Program modules may include routines, programs, objects, components, data structures, etc. that perform particular tasks or implement particular abstract data types. Functionalities of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields to locations in a computer-readable medium, so that the locations convey how the fields are related. However, any suitable mechanism may be used to relate information in fields of a data structure, including through the use of pointers, tags, and/or other mechanisms that establish how the data elements are related.

Various features and aspects of the present disclosure may be used alone, in any combination of two or more, or in a variety of arrangements not specifically described in the foregoing, and are therefore not limited to the details and arrangement of components set forth in the foregoing description or illustrated in the drawings. For example, aspects described in one embodiment may be combined in any manner with aspects described in other embodiments.

Also, the techniques described herein may be embodied as methods, of which examples have been provided. The acts performed as part of a method may be ordered in any suitable way. Accordingly, embodiments may be constructed in which acts are performed in an order different from illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

Also, the phraseology and terminology used herein is for the purpose of description and should not be regarded as limiting. The use of “including,” “comprising,” “having,” “containing,” “involving,” “based on,” “according to,” “encoding,” and variations thereof herein, is meant to encompass the items listed thereafter and equivalents thereof as well as additional items.

1. A computer-implemented method for updating one or more aspects of an inference model while the inference model is being used by an embedded system of an energy application, the computer-implemented method comprising:
storing at a first memory location of a memory associated with an embedded system, a first instance of an inference model;
storing at a second memory location of the memory, a second instance of the inference model;
receiving, via a network, first updated information for the inference model;
updating the second instance of the inference model based on the first updated information, wherein updating the second instance of the inference model is performed while the inference model is configured to estimate at least one aspect of the energy application using the first instance of the inference model; and
configuring the embedded system to use the second instance of the inference model to estimate the at least one aspect of the energy application when updating the second instance of the inference model is complete.

2. The computer-implemented method of claim 1, wherein the first instance of the inference model comprises a first set of parameters associated with the inference model and the second instance of the inference model comprises a second set of parameters associated with the inference model.

3. The computer-implemented method of claim 2, wherein
the inference model comprises a machine learning model,
the first set of parameters comprises a first set of weights and/or biases for the machine learning model, and
the second set of parameters comprises a second set of weights and/or biases for the machine learning model.

4. The computer-implemented method of claim 1, wherein the first instance of the inference model and the second instance of the inference model are associated with different model architecture.

5. The computer-implemented method of claim 1, further comprising:
determining that the second instance of the inference model is not being used by the embedded system, wherein updating the second instance of the inference model is performed in response to determining that the second instance of the inference model is not being used by the embedded system.

6. The computer-implemented method of claim 5, wherein determining the second instance of the inference model is not being used by the embedded system is based, at least in part, on a value stored in a location of the memory.

7. The computer-implemented method of claim 1, wherein
receiving first updated information for the inference model comprises receiving a plurality of packets,
the computer-implemented method further comprises reassembling the plurality of packets according to an order identified in the plurality of packets to generate updated model parameters, and
updating the second instance of the inference model based on the first updated information comprises updating the second instance of the inference model based on the updated model parameters.

8. The computer-implemented method of claim 7, further comprising:
requesting via the network, retransmission of a packet when the plurality of packets includes a missing packet according to the order identified in plurality of packets.

9. The computer-implemented method of claim 7, wherein receiving the plurality of packets comprises receiving the plurality of packets via an input/output (I/O) channel.

10. The computer-implemented method of claim 9, wherein the I/O channel comprises a controller area network (CAN) bus.

11. The computer-implemented method of claim 7, further comprising:
sending via the network, an acknowledgement that the plurality of packets were received.

12. The computer-implemented method of claim 7, wherein reassembling the plurality of packets according to an order identified in the plurality of packets comprises reassembling the plurality of packets at the second memory location.

13. The computer-implemented method of claim 12, further comprising:
determining whether an updated second instance of the inference model using the updated model parameters is valid,
wherein updating the second instance of the inference model is performed in response to determining that the updated second instance of the inference model is valid.

14. The computer-implemented method of claim 13, wherein determining whether an updated second instance of the inference model using the updated model parameters is valid comprises using a checksum technique.

15. The computer-implemented method of claim 13, further comprising:
discarding the updated second instance of the inference model when it is determined that the updated second instance of the inference model is not valid or when the plurality of packets includes a missing packet according to the order identified in plurality of packets.

16. The computer-implemented method of claim 1, wherein the at least one aspect of the energy application includes one or more of state of charge or state of health of an energy storage management system of the energy application.

17. The computer-implemented method of claim 16, wherein the energy application comprises an electric vehicle.

18. The computer-implemented method of claim 1, wherein configuring the embedded system to use the second instance of the inference model to estimate the at least one aspect of the energy application when updating the second instance of the inference model is complete comprises:
changing a value stored in a location of the memory, wherein the value corresponds to the first instance of the inference model or the second instance of the inference model.

19. The computer-implemented method of claim 18, wherein the location of the memory comprises a register and the value of stored in the location of the memory is a binary value.

20. The computer-implemented method of claim 18, wherein changing the value stored in a location of the memory comprises changing the value while the embedded system is configured to use the first instance of the inference model to estimate the at least one aspect of the energy application.

21. The computer-implemented method of claim 1, wherein configuring the embedded system to use the second instance of the inference model to estimate the at least one aspect of the energy application when updating the second instance of the inference model is complete comprises updating a pointer in the memory.

22. The computer-implemented method of claim 1, further comprising:
receiving via the network, second updated information for the inference model; and
updating the first instance of the inference model based on the second updated information, wherein updating the first instance of the inference model is performed while the inference model is configured to estimate at least one aspect of the energy application using the second instance of the inference model.

23. The computer-implemented method of claim 22, further comprising:
configuring the embedded system to use the first instance of the inference model to estimate the at least one aspect of the energy application when updating the first instance of the inference model is complete.

24. A system comprising:
at least one processor; and
at least one computer-readable medium having stored thereon instructions which, when executed, program the at least one processor to perform the method of any of claims 1-23.

25. At least one computer-readable medium having stored thereon instructions which, when executed, program at least one processor to perform the method of any of claims 1-23.
